(19) United States
(12) Patent Application Publication
(10) Pub. No.: US 2024/0107373 A1
(43) Pub. Date: Mar. 28, 2024

(54) WIRELESS COMMUNICATION METHOD AND ELECTRONIC DEVICE FOR TIME-SENSITIVE NETWORK

(71) Applicant: ELECTRONICS AND TELECOMMUNICATIONS RESEARCH INSTITUTE, Daejeon (KR)

(72) Inventors: Jae Sun CHA, Daejeon (KR); Tae Joon PARK, Daejeon (KR); Eun-Hee KIM, Daejeon (KR); Kyeseon LEE, Daejeon (KR)

(21) Appl. No.: 18/230,742

(22) Filed: Aug. 7, 2023

(30) Foreign Application Priority Data
Sep. 27, 2022 (KR) 10-2022-0122728
Jun. 19, 2023 (KR) 10-2023-0078121

(51) Int. Cl. H04W 28/06; H04W 76/10

(52) U.S. Cl. CPC H04W 28/06; H04W 76/10

(57) ABSTRACT

Provided is a communication method and an electronic device performing the communication method. The communication method includes establishing a wireless connection for transmission of data, generating a medium access control (MAC) frame including a header formed only of a frame control field based on a type of the data, and transmitting the MAC frame including the data.

### CROSS-REFERENCE TO RELATED APPLICATIONS

This application claims the benefit of Korean Patent Application No. 10-2022-0122728 filed on Sep. 27, 2022, Korean Patent Application No. 10-2023-0078121 filed on Jun. 19, 2023, in the Korean Intellectual Property Office, the entire disclosure of which is incorporated herein by reference for all purposes.

### BACKGROUND

### 1. Field of the Invention

One or more embodiments relate to a wireless communication method and an electronic device for a time-sensitive network (TSN).

### 2. Description of Related Art

Time-sensitive network (TSN) technology is Ethernet extended technology defined by the institute of electrical and electronics engineers (IEEE) and is network infrastructure technology capable of transmitting a packet of data in a deterministic method. Deterministic packet transmission refers to guaranteeing the transmission of a packet at an exact timing without delay or interruption in real-time communication. The TSN technology may function as a communication of a signal and/or information in a loop control system. For example, a TSN may serve as a communication function for transmitting a signal and/or information generated by certain devices (e.g., a sensor, a controller, an actuator, etc.) in a system to other devices (e.g., a sensor, a controller, an actuator, etc.) The communication in the automation system field may need to satisfy the periodicity and determinacy, and in particular, the communication in the automation system such as a loop control system may require a higher level of periodicity and determinacy. For example, in the case of isochronous data that is mainly exchanged in a loop control system, the length and transmission period of packets are very short and it may be important for packets to arrive at a destination without loss in a predetermined delay time and delay time deviation. To satisfy these high level requirements, the current TSN technologies that operate based on wired networks are mainly applied to industrial sites (e.g., industrial sites to which an automation system is applied), but due to the feature of industrial sites, there may be sites where the wired communication technology is difficult to apply and the maintenance cost is high, so TSN technology capable of operating in a wireless communication method may be required.

The above description is information the inventor(s) acquired during the course of conceiving the present disclosure, or already possessed at the time, and is not necessarily art publicly known before the present application was filed.

### SUMMARY

Embodiments provide a medium access control (MAC) protocol frame structure and an operating method of a time-sensitive network (TSN) for deterministic wireless transmission of isochronous data having characteristics of short length and short period.

However, the technical aspects are not limited to the aspects above, and there may be other technical aspects.

According to an aspect, there is provided a communication method including establishing a wireless connection for transmission of data, generating a MAC frame including a header formed only of a frame control field based on a type of the data. and transmitting the MAC frame including the data.

The type of the data may be isochronous data.

The establishing of the wireless connection may include transmitting a frame including identification information on transmission of the data and information on an upper protocol of the MAC frame.

The identification information may include at least one of a wireless connection identifier (CID), a band index, a channel index, and a slot index.

The information on the upper protocol may include information on compression and restoration of a header of the upper protocol.

According to another aspect, there is provided an electronic device including one or more memories configured to store one or more instructions, one or more processors electrically connected to the one or more memories and configured to execute the one or more instructions, wherein, when the one or more instructions are executed by the one or more processors, the instructions cause the electronic device to perform a plurality of operations, wherein the plurality of operations includes establishing a wireless connection for transmission of data, generating a MAC frame including a header formed only of a frame control field based on a type of the data, and transmitting the MAC frame including the data.

The type of the data may be isochronous data.

The establishing of the wireless connection may include transmitting a frame including identification information on transmission of the data and information on an upper protocol of the MAC frame.

The identification information may include at least one of a wireless CID, a band index, a channel index, and a slot index.

The information on the upper protocol may include information on compression and restoration of a header of the upper protocol.

According to still another aspect, there is provided a communication method including by transmitting a frame including identification information on transmission of data and information on an upper protocol of a MAC frame, establishing a wireless connection for transmission of the data, generating a MAC frame including a header formed only of a frame control field based on a type of the data, and transmitting the MAC frame including the data.

The type of the data may be isochronous data.

The identification information may include at least one of a wireless CID, a band index, a channel index, and a slot index.

The information on the upper protocol may include information on compression and restoration of a header of the upper protocol.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a loop control system that is one of automation systems according to an embodiment;

FIG. 2 is a diagram illustrating a time-sensitive network (TSN) structure according to an embodiment;

FIG. 3 is a diagram illustrating an example of a structure of a wireless frame for wireless communication according to an embodiment;

FIG. 4 is a diagram illustrating another example of a structure of a wireless frame for wireless communication according to an embodiment;

FIG. 5 is an example diagram illustrating of a structure of a medium access control (MAC) frame for a TSN according to an embodiment;

FIG. 6 is a diagram illustrating a structure of a MAC frame configured differently according to the type of a frame according to an embodiment;

FIG. 7 is a diagram illustrating a registration procedure for accessing a TSN of an end device (ED) according to an embodiment;

FIG. 8 is a diagram illustrating a procedure for establishing a wireless connection for transmission of isochronous data, according to an embodiment;

FIG. 9 is an example illustrating the location and size of a slot of a wireless frame for wireless communication according to an embodiment;

FIG. 10 is a diagram illustrating a procedure for changing a wireless connection, according to an embodiment;

FIG. 11 is a diagram illustrating a procedure for deleting a wireless connection, according to an embodiment;

FIG. 12 is a flowchart illustrating a communication method for a TSN according to an embodiment; and

FIGS. 13 and 14 are schematic block diagrams illustrating an electronic device according to an embodiment.

### DETAILED DESCRIPTION

The following detailed structural or functional description is provided as an example only and various alterations and modifications may be made to the examples. Here, examples are not construed as limited to the disclosure and should be understood to include all changes, equivalents, and replacements within the idea and the technical scope of the disclosure.

Terms, such as “first”, “second”, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a,” “an,” and “the” are intended to include the plural forms as well, unless the context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. It will be further understood that the terms “comprises/including” and/or “includes/including” when used herein, specify the presence of stated features, integers, operations, operations, elements, and/or components, but do not preclude the presence or addition of one or more other features, integers, operations, operations, elements, components and/or groups thereof.

Unless otherwise defined, all terms, including technical and scientific terms, used herein have the same meaning as commonly understood by one of ordinary skill in the art to which this disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

As used in connection with the present disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an example, the module may be implemented in a form of an application-specific integrated circuit (ASIC).

The term “unit” or the like used herein may refer to a software or hardware component, such as a field-programmable gate array (FPGA) or an application-specific integrated circuit (ASIC), and the “unit” performs predefined functions. However, “unit” is not limited to software or hardware. The “unit” may be configured to reside on an addressable storage medium or configured to operate one or more processors. Accordingly, the “unit” may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operate on one or more central processing units (CPUs) within a device or a security multimedia card. In addition, “unit” may include one or more processors.

Hereinafter, the examples will be described in detail with reference to the accompanying drawings. When describing the embodiments with reference to the accompanying drawings, like reference numerals refer to like elements and any repeated description related thereto will be omitted.

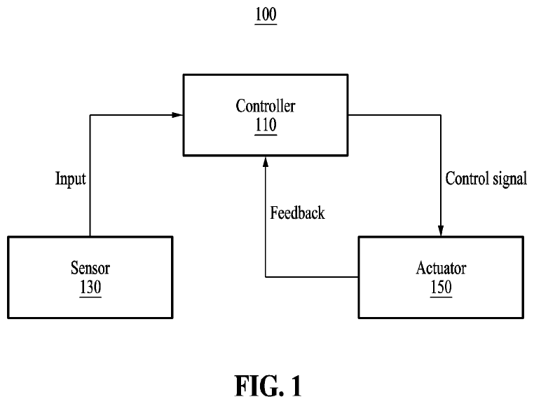

FIG. 1 is a diagram illustrating a loop control system that is one of automation systems according to an embodiment.

Referring to FIG. 1, according to an embodiment, industrial automation may refer to automating the entire process from the product design and manufacturing to shipment through control of a system and/or process. The industrial automation field is a representative field to which time-sensitive network (TSN) technology is applied and may be a field requiring deterministic packet transmission. A loop control system (e.g., a system 100) is a typical automation system to which industrial automation is applied and may be a system in which an input, control, and output are sequentially performed in a predetermined order. A sensor (e.g., a sensor 130) may provide information (e.g., the temperature, pressure, length, etc.) necessary for controlling a system to a controller (e.g., a controller 110). The controller 110 may generate a control signal for controlling an actuator (e.g., an actuator 150) based on the information received from the sensor 130. A closed-loop control system is a type of loop control systems, in which information output from the actuator 150 may be fed back to the controller 110 so that the controller 110 uses the information when generating a control signal. The TSN may function to communicate with a signal and/or information in the loop control system. The traffic exchanged in the automation system such as the loop control system is mainly isochronous traffic (e.g., isochronous data), which may require a high level of periodicity and determinacy. The wireless communication technology according to the related art does not satisfy these requirements of the industrial automation system. For example, IEEE802.11, a standard prepared by the IEEE 802 committee, has limitations in transmitting short length (e.g., within 10 to 20 bytes) packets transmitted from a plurality of end devices (EDs) in a very short period (e.g., 125 microsecond (μs)) due to physical layer overhead (e.g., preamble) and MAC layer overhead (e.g., a MAC header).

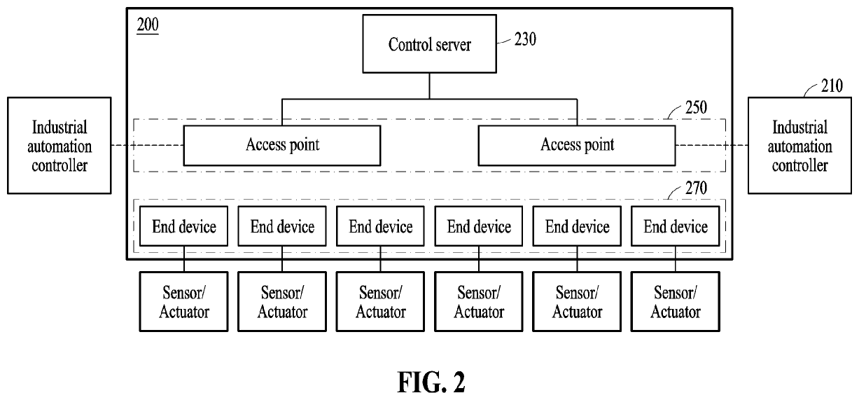

FIG. 2 is a diagram illustrating a TSN structure according to an embodiment.

Referring to FIG. 2, according to an embodiment, a TSN (e.g., a TSN 200) may include a control server (CS) (e.g., a CS 230), an access point (AP) (e.g., an AP 250), and an ED (e.g., an ED 270). The AP 250 may include a plurality of APs (e.g., n APs, where n is a natural number greater than 1). The ED 270 may include a plurality of EDs (e.g., n EDs, where n is a natural number greater than 1). The CS 230 may manage the entire configuration with the TSN 200. The AP 250 may manage a certain network that may be configured of a plurality of EDs. The CS 230 may control the entire network in a centralized method or may be at an AP (e.g., the AP 250) to control the entire network in a distributed method. For convenience of description, FIG. 2 is a diagram illustrated by assuming that the CS 230 controls the entire network in a centralized method, and the CS 230 and the AP 250 may be physically separated from each other. An industrial automation controller (IAC) 210 (e.g., the controller 110 of FIG. 1), a sensor (e.g., the sensor 130), and an actuator (e.g., the actuator 150) may communicate using the TSN. For example, the AP 250 and the ED 270 may be responsible for wireless communication of data generated from the controller 110 and an external device (e.g., the sensor 130 and/or the actuator 150). Information collected by the sensor 130 may be wirelessly transmitted from the ED 270 to the AP 250 and then transmitted to the controller 110 again. Based on the received information, the controller 110 may generate a control signal for controlling the actuator 150 and transmit the control signal to the AP 250, and the control signal may be transmitted to the target actuator, the actuator 150, through the ED 270 again. The AP 250, the controller 110, the ED 270, the sensor 130, and the actuator 150 may exchange information using a universal asynchronous receiver transmitter (UART) or Ethernet. Data transmitted between the sensor 130 and the actuator 150 may include isochronous data requiring a high level of periodicity and determinacy and non-isochronous data not requiring periodicity or determinacy.

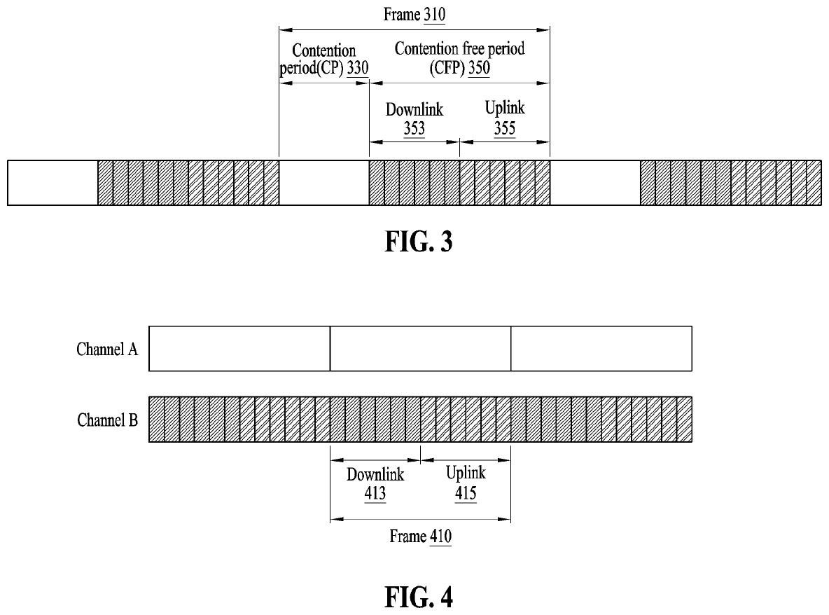

FIG. 3 is a diagram illustrating an example of a structure of a wireless frame for wireless communication according to an embodiment.

Referring to FIG. 3, according to an embodiment, FIG. 3 may be a diagram illustrating a case (e.g., a single channel mode) in which isochronous data and non-isochronous data are transmitted from the same wireless channel. A frame 310 may include a contention period (CP) (e.g., a CP 330) and a contention free period (CFP) (e.g., a CFP 350). The CP 330 is a period for transmitting non-isochronous data and may be a period to which data transmission of a carrier sense multiple access with collision avoidance (CSMA/CA)-based contention method is applied. The contention method may refer to a method in which a plurality of users competes over one channel and share the one channel. When data is transmitted using the CP 330, whenever data transmission is required, resources (e.g., lines, etc.) are acquired in a CSMA/CA method and data is transmitted through the acquired resources, so that a prior procedure (e.g., a wireless connection establishment procedure) may not be required. The CFP 350 is a period for transmitting isochronous data and may be a period to which a time division multiple access (TDMA) method for transmitting data through a contention-free pre-allocated slot is applied. The CFP 350 may include an uplink 355 for data transmission from an ED (e.g., the ED 270 of FIG. 2) to an AP (e.g., the AP 250) and a downlink 353 for data transmission from the AP 250 to the ED 270. The slot allocation for data transmission may be performed through a wireless connection establishment procedure that is performed before data transmission, and a plurality of slots may be allocated according to a wireless connection period and data size.

FIG. 4 is a diagram illustrating another example of a structure of a wireless frame for wireless communication according to an embodiment.

Referring to FIG. 4, according to an embodiment, FIG. 4 may be a diagram illustrating a case in which isochronous data and non-isochronous data are transmitted on different wireless channels. When a plurality of wireless channels (e.g., channel A and channel B) is used for communication (e.g., a multi-channel mode), each wireless channel may be designated as a channel (e.g., channel A) for transmission of non-isochronous data and as a channel (e.g., channel B) for transmission of isochronous data. For example, channel A may be a channel through which non-isochronous data is transmitted in a CSMA/CA method, such as a CP (e.g., the CP 330 of FIG. 3). Channel B may be a channel through which isochronous data is transmitted in a contention-free TDMA method, such as a CFP (e.g., the CFP 350 of FIG. 3). One frame (e.g., a frame 410) in channel B may include a downlink (e.g., a downlink 413) and an uplink (e.g., an uplink 415).

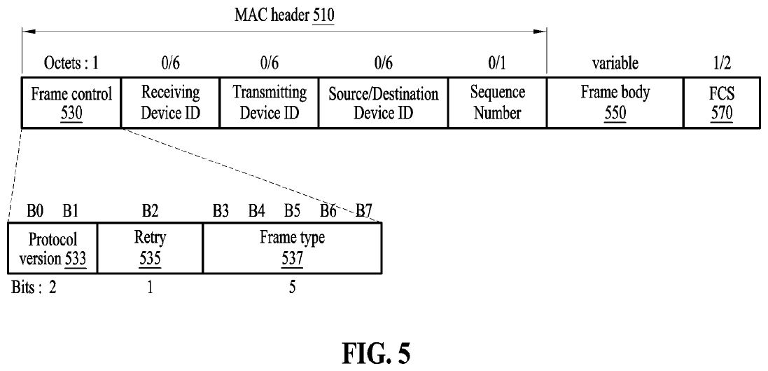

FIG. 5 is an example diagram illustrating of a structure of a MAC frame for a TSN according to an embodiment.

Referring to FIG. 5, according to an embodiment, a MAC frame may include a MAC header (e.g., a MAC header 510), a frame body field (e.g., a frame body field 550), and a frame check sequence (FCS) field (e.g., an FCS field 570). The MAC header may include a frame control field (e.g., a frame control field 530), a receiving device identifier (ID) field, a transmitting device ID field, a source/destination device ID field, and a sequence number field. The receiving device ID field is a field for identifying a device that receives a MAC frame and may be a field including an ED (e.g., the ED 270 of FIG. 2) designated as a device that directly receives the MAC frame and/or an n-byte MAC address (e.g., a 6-byte MAC address) of an AP (e.g., the AP 250). The transmitting device ID field is a field for identifying a device that transmits a MAC frame and may be a field including an ED that transmits a current MAC frame and/or an n-byte MAC address (e.g., a 6-byte MAC address) of an AP. The source/destination device ID field may be a field for identifying a device (e.g., the sensor 130 and the actuator 150 of FIG. 1) designated as a source or a destination of data (e.g., data in the packet form) that is transmitted included in the MAC frame. In an uplink MAC frame transmitted from the ED 270 to the AP 250, the n-byte MAC address (e.g., the 6-byte MAC address) of a device (e.g., the IAC 210) designated as a destination may be in the source/destination device ID field. In a downlink MAC frame transmitted from the AP 250 to the ED 270, the n-byte MAC address of (e.g., the 6-byte MAC address) of a device (e.g., the IAC 210) designated as a source may be in the source/destination device ID field. The sequence number field may be a field of an m-byte length (e.g., a 1-byte length) for indicating the sequence number of a MAC frame. The FCS field may include a cyclic redundancy check (CRC), which is an error correction code for protecting a MAC frame. The value of the FCS field may be a CRC value calculated over all the fields from a frame control field to a frame body field. The length of the FCS field may vary depending on the type of a MAC frame.

Among fields forming a MAC frame, the lengths of fields (e.g., the receiving device ID field, the transmitting device ID field, the source/destination device ID field, the sequence number field, and the FCS field) other than the frame control field 530 and the frame body field 550 and whether the fields other than the frame control field 530 and the frame body field 550 are in the MAC frame may be determined by a value of a frame type field (e.g., a frame type field 537), which is a lower field of the frame control field (e.g., the frame control field 530). The frame control field 530 may include a protocol version field 533, a retry field 535, and the frame type field 537. The protocol version field 533 may be a field of an n-bit length (e.g., a 2-bit length) for indicating a protocol version of a current system. The retry field 535 may be a field of a length of m-bit (e.g., 1-bit) for indicating that a MAC frame is a retransmission of a previously transmitted MAC frame. The frame type field 537 is a field of an n-bit length (e.g., a 5-bit length) for indicating the type of a MAC frame supported by a system and depending on a function of the MAC frame and the type of data in the MAC frame, the value of the frame type field 537 may vary. Table 1 below may represent definitions according to values of the frame type field 537.

TABLE 1

| Frame Type | | | Sending | |
|---|---|---|---|---|
| (B7 B6 B5 B4 | | | Device | |
| B3) | Description | Type | ED | AP |
| 00000 | Beacon | Management | | ◯ |
| 00001 | Registration Request | Management | ◯ | |
| 00010 | Registration Response | Management | | ◯ |
| 00011 | Delay Request | Management | ◯ | |
| 00100 | Delay Response | Management | | ◯ |
| 00101 | Connection Addition Request | Management | | ◯ |
| 00110 | Connection Addition Response | Management | ◯ | |
| 00111 | Connection Change Request | Management | | ◯ |
| 01000 | Connection Change Response | Management | ◯ | |
| 01001 | Connection Deletion Request | Management | | ◯ |
| 01010 | Connection Deletion Response | Management | ◯ | |
| 01011-01111 | Reserved | Management | — | — |
| 10000 | Request-To-Send (RTS) | Control | ◯ | ◯ |
| 10001 | Clear-To-Send (CTS) | Control | ◯ | ◯ |
| 10010 | Acknowledgement (ACK) | Control | ◯ | ◯ |
| 10011-10111 | Reserved | Control | — | — |
| 11000 | Non-Isochronous Data | Data | ◯ | ◯ |
| 11001 | Isochronous Data | Data | ◯ | ◯ |
| 11010-11111 | Reserved | Data | — | — |

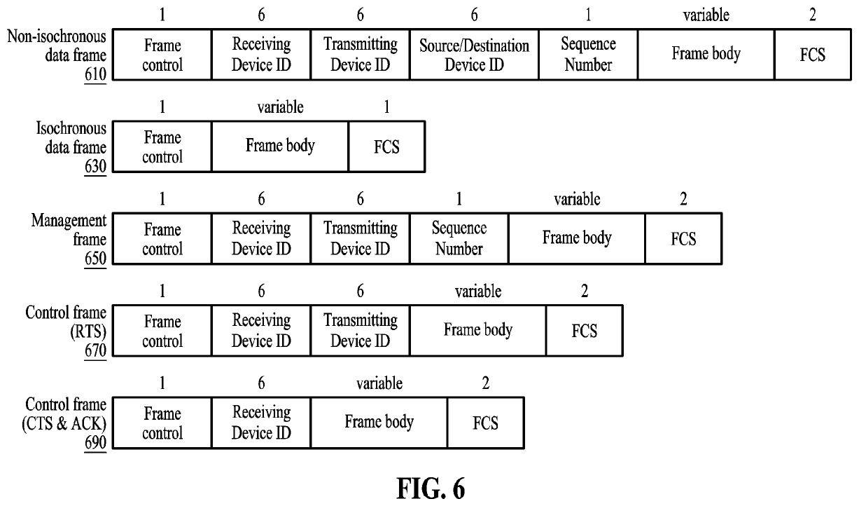

FIG. 6 is a diagram illustrating a structure of a MAC frame configured differently according to the type of a frame according to an embodiment.

Referring to FIG. 6, according to an embodiment, as shown in Table 1, a value (e.g., 00000 to 11111) of a frame type field (e.g., the frame type field 537 of FIG. 5) may indicate the type of a MAC frame. The type of a MAC frame may include a management frame (e.g., a management frame 650), control frames (e.g., a ready-to-send (RTS) frame 670 and a-clear-to send (CTS) and acknowledgement (ACK) frame 690), and a data frame. The data frame is a type of a MAC frame for data transmission and may be a frame including isochronous data or non-isochronous data in a frame body field. The data frame may be divided into an isochronous data frame (e.g., an isochronous data frame 630) or a non-isochronous data frame (e.g., a non-isochronous data frame 610) depending on the type of data in the frame body field. MAC frames other than the isochronous data frame 630 may include the receiving device ID field. MAC frames other than the isochronous data frame 630 and the CTS and ACK frame 690 may include the transmitting device ID field. The non-isochronous data frame 610 may include the source/destination device ID field. MAC frames other than the management frame 650 and the isochronous data frame 630 may include the sequence number field. The isochronous data frame 630 may include a MAC header formed only of a frame control field. The length of a frame body field of each MAC frame may vary and information in the frame body field may be determined according to the value of a frame type field as shown in Table 1. The length of the FCS field may vary depending on the type of a MAC frame. For example, the isochronous data frame 630 may include an FCS field of a 1-byte length and the remaining MAC frames may include an FCS field of a 2-byte length.

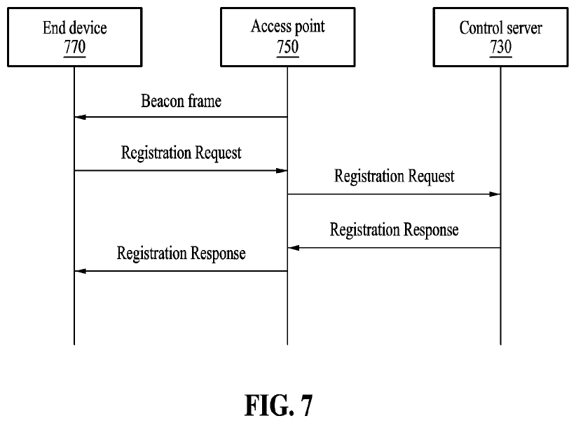

FIG. 7 is a diagram illustrating a registration procedure of an ED for accessing a TSN according to an embodiment.

Referring to FIG. 7, according to an embodiment, an AP (e.g., an AP 750) may provide an ED (e.g., an ED 770) with identification information of the AP 750 and identification information of a wireless network managed by the AP 750. The ED 770, the AP 750, and a CS 730 may be substantially the same as the ED 270, the AP 250, and the CS 230 described with reference to FIG. 2, respectively. The AP 750 may periodically broadcast a beacon frame to provide identification information to the ED 770. The beacon frame may be a wireless frame signal having a regular period that allows a device (e.g., the AP 750) to announce the presence of the device, to make the device easy to find, and to participate in communication. The beacon frame may include identification information of the AP 750, information (e.g., the transmission period of the beacon frame, the timestamp of transmission, the sequence number of a wireless frame including a currently transmitted beacon message) on a beacon, and information (e.g., the length of a MAC frame, configuration information of a wireless channel, slot configuration information for isochronous data transmission, and wireless channel information for isochronous data transmission) on a wireless frame operated by the AP 750. The wireless channel configuration information may include information on a channel operation mode, a CP/CFP, and the number of channels dedicated to isochronous data. The slot configuration information for isochronous data transmission may include information on the length of a slot, the number of slots, and slot configuration. The wireless channel information for isochronous data transmission may include a frequency band and channel identifier information. The ED 770 desired to access a TSN (e.g., the TSN 200 of FIG. 2) may receive a beacon frame broadcast by the AP 750. The ED 770 may receive a beacon frame, identify the AP 750 broadcasting the beacon frame, and obtain information on a wireless frame operated by the AP 750. Since the ED 770 does not know information (e.g., the mode of a channel, the boundary of a CP/CFP, etc.) on a currently operated wireless channel before receiving a beacon frame, the access to an uplink for information transmission to the AP 750 may be prevented. The ED 770 receiving the beacon frame may access the TSN 200 through a registration procedure. For example, in the case of a single channel mode using one channel, the ED 770 may perform a registration procedure using a CP (e.g., the CP 330 of FIG. 3). The length of the CP 330 may be obtained through wireless frame information in the beacon frame. For example, the length of the CP 330 may be calculated by subtracting a value obtained by multiplying the number of slots by the slot length from the length of the entire wireless frame (e.g., the frame 310). In the case of a multi-channel mode using a plurality of channels, since a beacon frame may be transmitted to a dedicated channel for non-isochronous data transmission, the ED 770 may perform a registration procedure using a channel (e.g., channel A of FIG. 4) for non-isochronous data transmission. The registration procedure may be initiated while the ED 770 transmits a registration request frame to the AP 750. The registration request frame may include an identifier of the ED 770 that transmits the registration request frame and an identifier of a host device (e.g., the sensor 130 and the actuator 150 of FIG. 1) interworking with the ED 770. The AP 750 receiving the registration request frame may request permission for the ED 770 to access the TSN 200 by transmitting a registration request network message (e.g., a wired communication message) to the CS 730. The CS 730 may determine whether the ED 770 is permitted to access the TSN 200 by determining whether the ED 770 is pre-authorized. The CS 730 may notify whether the ED 770 is permitted to access the TSN 200 by transmitting a registration response network message to the AP 750. The AP 750 receiving the registration response network message may notify whether the ED 770 is permitted to access the TSN 200 by transmitting a registration response frame to the ED 770. When the ED 770 requesting access to the TSN 200 is not pre-authorized to access the TSN 200, the CS 730 may not permit access to the TSN 200 of the ED 770. For example, the CS 730 may not permit access to the TSN 200 of the ED 770 by transmitting a registration response network message including a result field set to fail to the AP 750. The AP 750 may transmit, to the ED 770, a registration response frame including a message not permitting access to the TSN 200 of the ED 770. The ED 770 receiving the registration response frame including a network access non-permission message (e.g., a registration failure) may retry registration to the AP 750 according to the failure reason in the registration response frame or may search for another AP other than the AP 750. When the TSN 200 is managed in a distributed method by the AP 750, the AP 750 may receive a registration request frame from the ED 770 and may then directly determine whether the ED 770 is permitted to access a network and transmit a registration response frame including a determination result to the ED 770. After the end of a normal registration procedure, the ED 770 may receive and transmit data (e.g., non-isochronous data) from and to the AP 750.

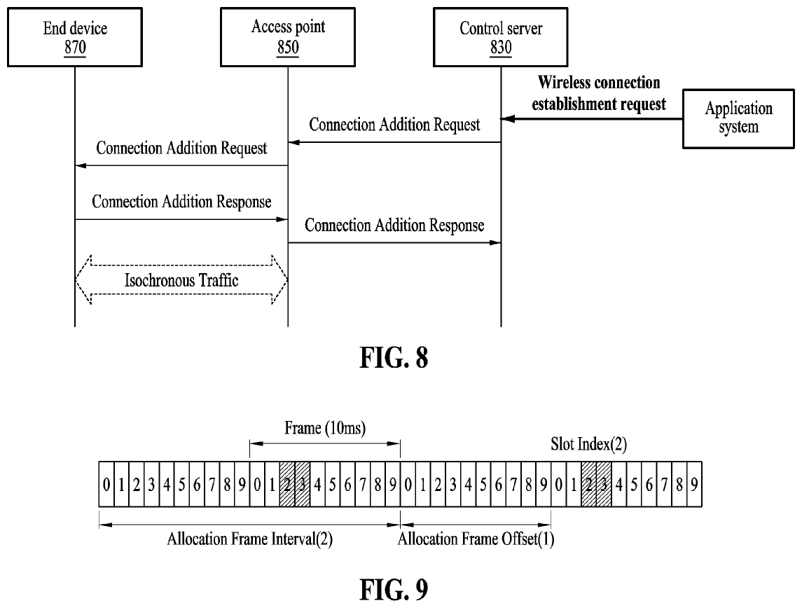

FIG. 8 is a diagram illustrating a procedure for establishing a wireless connection for transmission of isochronous data, according to an embodiment.

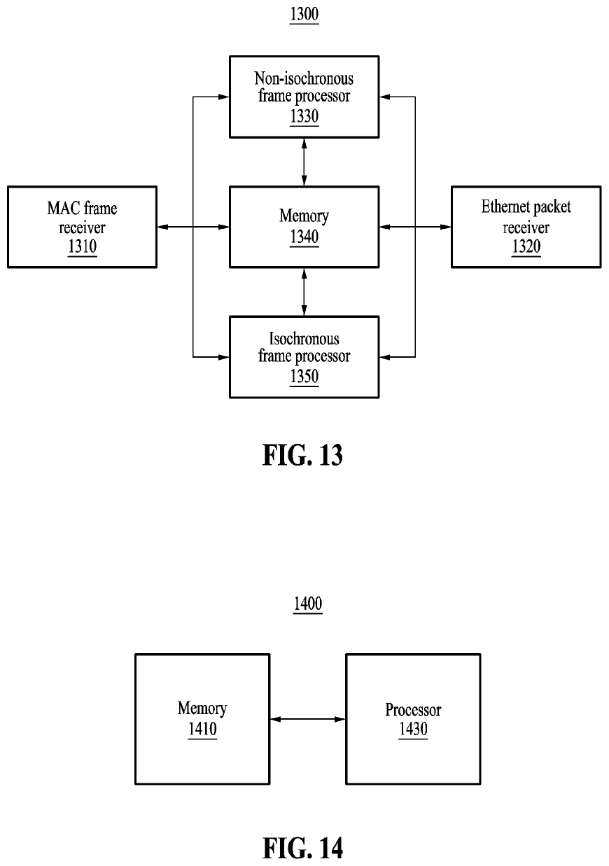

Referring to FIG. 8, according to an embodiment, an electronic device (e.g., an electronic device 1300 of FIG. 13) may establish a wireless connection for transmission of data (e.g., isochronous data). The electronic device 1300 may receive isochronous data in the form of a packet from an application system (e.g., the IAC 210) outside a network (e.g., the TSN 200 of FIG. 2). To transmit the received isochronous data, the electronic device 1300 may convert data in the form of a packet (e.g., an Ethernet packet) into the form of a MAC frame (e.g., the isochronous data frame 630 of FIG. 6). When the size of a wireless resource (e.g., a slot) for transmitting the MAC frame is not large enough, the electronic device 1300 may not transmit the packet through the MAC frame at once. A method of dividing packets, converting the packets into a plurality of MAC frames, and transmitting the plurality of MAC frames to a destination is possible, but delay time may increase due to an increase in the number of packet divisions and frame transmission. When a MAC header of the isochronous data frame 630 is formed only of a frame control field (e.g., the frame control field 530 of FIG. 5) and the length of the frame is minimized, the efficiency of isochronous data transmission may increase. For example, a header of the isochronous data frame 630 may not include identification information (e.g., the receiving device ID, transmitting device ID, source/destination device ID, etc.) on data transmission and may only include the frame control field 530.

The electronic device 1300 may transmit information on an upper protocol of the isochronous data frame 630 as identification information on isochronous data transmission through a wireless connection establishment procedure. Table 2 may be a table indicating wireless connection establishment information in a frame (e.g., a connection addition request frame) requesting wireless connection establishment for transmission of the isochronous data frame 630.

TABLE 2

| Name | | Description |
|---|---|---|
| Wireless Connection | CID | Wireless CID for Transmission |
| Identifier | | of Isochronous Data |
| Wireless Channel | Band Index | Frequency Band Index |
| | Channel Index | Wireless Channel Index |
| Slot (Allocation Resource) | Allocation Frame Interval | Slot Allocation Period (Frame |
| Period | | Unit) |
| Slot (Allocation Resource) | Allocation Frame Offset | Offset (O_{Frame}) of Frame in |
| Location and Size | | which slots are allocated |
| | Slot Index | Slot Index (O_{Slot}) |
| | Number of Slots | The Number of Consecutive |
| | | Slots allocated for Isochronous |
| | | Data Transmission |
| Wireless Connection | Direction | 0: Uplink |
| Direction | | 1: Downlink |
| Protocol Header | Ethernet Protocol | Information for Compression |
| Compression Information | Information | and Restoration of Ethernet |
| | | Protocol Header |
| | UDP/TCP/IP Protocol | Information for Compression |
| | Information | and Restoration of UDP/IP or |
| | | TCP/IP Protocol Header |

The connection identifier (CID) may be a wireless CID defined to identify a wireless connection for transmission of the isochronous data frame 630. The band index and channel index may be information for identifying the frequency channel of a slot allocated for data transmission. The band index may be a number of a frequency band (e.g., 2.4 gigahertz (GHz), 5 GHz, or 6 GHz) to which a wireless channel belongs. The channel index may be a number of a wireless channel defined by the corresponding frequency band. The CID may be used to identify a wireless connection but the wireless connection may be identified without using the CID. For example, when the number of wireless connections for transmission of the isochronous data frame 630 is limited to one per ED (e.g., an ED 870), a slot or slot group allocated to each ED may also be limited to one, so a wireless connection may be identified as a combination of the band index, the channel index, and the slot index. The allocation frame interval may indicate an allocation period of a slot allocated through a wireless connection establishment procedure. The unit of the allocation frame interval may be the length of a frame (e.g., the frame 310 or the frame 410). The allocation frame offset, the slot index, and the number of slots may indicate allocation locations and sizes of wireless resources (e.g., slots) corresponding to the corresponding wireless connection. The allocation frame offset may indicate a relative location of a wireless frame to which a slot is allocated in an allocation period. The slot index may indicate a relative location of an allocated slot in a wireless frame designated by the allocation frame offset. The number of slots may indicate the number of slots consecutively allocated from a slot designated by the slot index for the corresponding wireless connection. The direction may be a parameter indicating whether a wireless connection established through a wireless connection establishment procedure is a downlink connection or an uplink connection. The protocol header compression information may be a parameter for compressing and restoring header information of an upper protocol in a packet received by an AP (e.g., an AP 850) or an ED (e.g., an ED 870) from an external device (e.g., the IAC 210 of FIG. 2 and the sensor 130 and the actuator 150 of FIG. 1). The protocol header compression information may include Ethernet protocol information and user datagram protocol (UDP)/transmission control protocol (TCP)/Internet protocol (IP) information. The Ethernet protocol information may include information (e.g., a destination MAC address, a source MAC address, and type information) in a header of the Ethernet protocol. The UDP/TCP/IP protocol information may include information (e.g., a destination IP address, a source IP address, a destination port number, a source port number, etc.) in headers of the UDP, TCP, and IP protocol. The protocol header compression information may be used to efficiently transmit the isochronous data frame 630 using limited wireless resources. For example, when data in an Ethernet packet form is converted into the isochronous data frame 630, the electronic device 1300 may delete information in the Ethernet protocol information or the UDP/TCP/IP protocol information and may generate the isochronous data frame 630 including a header formed only of the frame control field 530. The electronic device 1300 receiving the generated isochronous data frame 630 may use information in the Ethernet protocol information or the UDP/TCP/IP protocol information when restoring the Ethernet packet from the received isochronous data frame 630.

The wireless connection establishment procedure for transmission of isochronous data may be initiated by an application system (e.g., the IAC 210) requesting a CS 830 to establish a wireless connection for transmission of isochronous data. The electronic device 1300 establishing a wireless connection for communication may include the ED 870 and the AP 850. The ED 870, the AP 850, and the CS 830 may be substantially the same as the ED 270, the AP 250, and the CS 230 described with reference to FIG. 2, respectively. The application system may include an application system and an application interworking with the ED 870. The application system may directly request a wireless connection establishment to the AP 850 according to the configuration of a network. For convenience of description, it is assumed that the application system of FIG. 8 requests the CS 830 to establish a wireless connection. The CS 830 receiving the wireless connection establishment request from the application system may transmit a connection addition request network message (e.g., a wired communication message) to the AP 850. The CS 830 may request the wireless connection establishment for transmission of isochronous data by transmitting the connection addition request network message to the AP 850. The AP 850 receiving the connection addition request network message may transmit a connection addition request frame to an ED (e.g., the ED 870) specified in the connection addition request network message. The AP 850 may request the wireless connection establishment by transmitting a connection addition request frame to the ED 870. The ED 870 receiving the connection addition request frame may transmit a connection addition response frame the AP 850. The AP 850 receiving the connection addition response frame may terminate the wireless connection establishment procedure by transmitting a connection addition response network message to the CS 830.

FIG. 9 is an example illustrating the location and size of a slot of a wireless frame for wireless communication according to an embodiment.

Referring to FIG. 9, according to an embodiment, FIG. 9 is an example diagram illustrating a structure of a wireless frame according to a setting of values of the allocation frame interval, the allocation frame offset, the slot index, and the number of slots. The value of allocation frame interval may indicate a slot allocation period. For example, when the value of the allocation frame interval is set to “2”, the slot allocation period may indicate lengths of two frames, and when the length of a frame is 10 milliseconds (ms), the slot allocation period may be 20 ms. The slot allocation location may be determined by the allocation frame offset, the slot Index, and the number of slots. For example, the value of allocation frame offset is “1”, the value of slot Index is “2”, and the number of slots is set to “2” may mean that two slots (number of slots=2) are allocated from the 3rd slot (slot Index=2) of the 2nd frame (allocation frame offset=1).

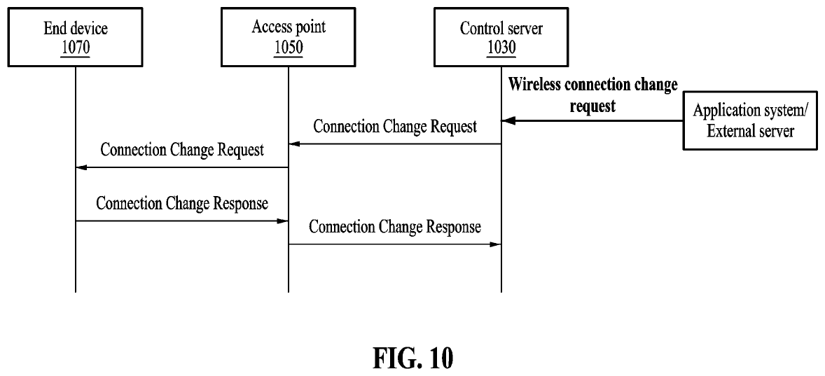

FIG. 10 is a diagram illustrating a procedure for changing a wireless connection, according to an embodiment.

Referring to FIG. 10, according to an embodiment, when a wireless connection change request occurs in an application system (e.g., the IAC 210 of FIG. 2) or an external server, a wireless connection change procedure may be initiated. An ED 1070, an AP 1050, and a CS 1030 may be substantially the same as the ED 270, the AP 250, and the CS 230 described with reference to FIG. 2, respectively. For convenience of description, it is assumed that a wireless connection change procedure is initiated by an application system or an external server in FIG. 10, but the wireless connection change procedure may be initiated by the CS 1030, the AP 1050, and the ED 1070, and an application system or an external server interworking with the ED 1070. The CS 1030 receiving a wireless connection change request from an application system or an external server may request a wireless connection change for transmission of an isochronous data frame (e.g., the isochronous data frame 630) by transmitting a connection change request network message (e.g., a wired communication message) to the AP 1050. The AP 1050 receiving the connection change request network message may identify a wireless connection to be changed through information in a received frame, and a transmission ED or a reception ED of the wireless connection. The AP 1050 may request a wireless connection change by transmitting a connection change request frame to the identified ED (e.g., the ED 1070) and receive a connection change response frame that is a response of the request. The AP 1050 receiving the connection change response frame from the ED 1070 may terminate a wireless connection change procedure by transmitting a connection change response network message to the CS 1030.

Table 3 may be a table indicating information in the connection change request frame. The information in the connection change request frame may include the same parameters as parameters in the connection addition request frame. The parameter value in the connection addition request frame that is set through the wireless connection establishment procedure may be changed to the parameter value in the connection change request frame.

TABLE 3

| Name | | Description |
|---|---|---|
| Wireless CID | CID | Wireless CID for Transmission |
| | | of Isochronous Data |
| Wireless Channel | Band Index | Frequency Band Index |
| | Channel Index | Wireless Channel Index |
| Slot (Allocation Resource) | Allocation Frame Interval | Slot Allocation Period (Frame |
| Period | | Unit) |
| Slot (Allocation Resource) | Allocation Frame Offset | Offset (O_{Frame}) of Frame in |
| Location and Size | | which slots are allocated |
| | Slot Index | Slot Index (O_{Slot}) |
| | Number of Slots | The Number of Consecutive |
| | | Slots allocated for Isochronous |
| | | Data Transmission |
| Wireless Connection | Direction | 0: Uplink |
| Direction | | 1: Downlink |
| Protocol Header | Ethernet Protocol | Information for Compression |
| | Information | and Restoration of Ethernet |
| | | Protocol Header |
| Compression Information | UDP/TCP/IP Protocol | Information for Compression |
| | Information | and Restoration of UDP/IP or |
| | | TCP/IP Protocol Header |

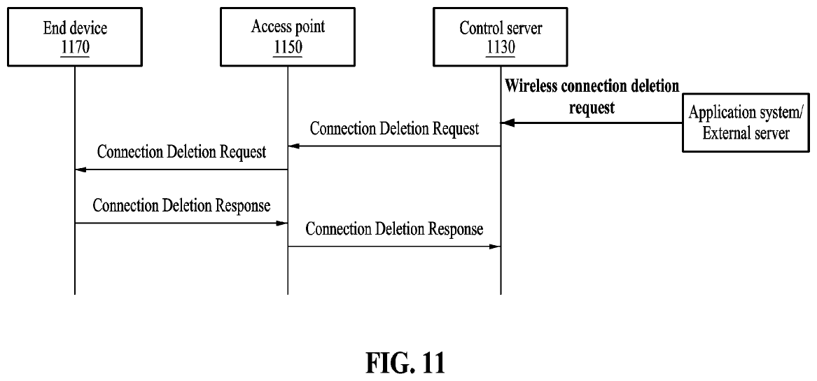

FIG. 11 is a diagram illustrating a procedure for deleting a wireless connection, according to an embodiment.

Referring to FIG. 11, according to an embodiment, when a wireless connection deletion request is generated by an application system (e.g., the IAC 210 of FIG. 2) or an external server, a wireless connection deletion procedure may be initiated. An ED 1170, an AP 1150, and a CS 1130 may be substantially the same as the ED 270, the AP 250, and the CS 230 described with reference to FIG. 2, respectively. For convenience of description, it is assumed that the wireless connection deletion procedure is initiated by an application system or an external server in FIG. 11 but the wireless connection deletion procedure may be initiated by the CS 1130, the AP 1150, the ED 1170, and an application system or application interworking with the ED 1170. The CS 1130 receiving a wireless connection deletion request from an application system or an external server may request the wireless connection deletion for transmission of an isochronous data frame (e.g., the isochronous data frame 630) by transmitting a connection deletion request network message (e.g., a wired communication message) to the AP 1150. The AP 1150 receiving the connection deletion request network message may identify a wireless connection to be deleted through information in a received frame, and a transmission ED or a reception ED of the wireless connection. The AP 1150 may request the wireless connection deletion by transmitting a connection deletion request frame to the identified ED (e.g., the ED 1170) and receive a connection deletion response frame that is a response of the request. The AP 1150 receiving the connection deletion response frame from the ED 1170 may terminate a wireless connection deletion change procedure by transmitting a connection deletion response network message to the CS 1130.

According to a wireless connection establishment procedure (e.g., the wireless connection establishment procedure of FIG. 8) for transmission of the isochronous data frame 630, a wireless connection change procedure (e.g., the wireless connection change procedure of FIG. 10), and a wireless connection deletion procedure, the information of the wireless connection may be stored in a transmission connection control table and a reception connection control table and may be referred to the wireless transmission of the isochronous data frame 630. Table 4 may indicate an example configuration of an entry in the transmission connection control table.

TABLE 4

| Parameters | Descriptions |
|---|---|
| Index | Connection Control Entry Index |
| Active | Active State of Connection Control Entry |
| | (0: Not Active, 1: Active) |
| Source MAC | Source MAC Address of Ethernet Packet |
| Address | |
| Destination | Destination MAC Address of Ethernet Packet |
| MAC Address | (In case of AP, same as MAC address of reception device |
| | in MAC frame) |
| Type | Type Field Value of Ethernet Header |
| Band Index | Frequency Band Index for MAC Frame Transmission |
| Channel Index | Wireless Channel Index for MAC Frame Transmission |
| Slot Index | TDM Slot Index for MAC Frame Transmission |
| Buffer Index | TX Buffer Index allocated for MAC Frame Transmission |

The entry may refer to a bundle of information on a certain wireless connection. The Index field may indicate an index of a connection control entry. The active field may indicate an active state of current entry information. The active state of entry information may indicate the validity of the entry information. The transmission connection control table may be implemented in the form of an array list and statically managed or may be implemented in the form of a linked list. When the transmission connection control table is implemented in the form of a connection list, the transmission connection control table may be managed by dynamically adding or deleting entries to the connection list whenever a wireless connection is established or deleted and, in this case, the index field and active field may not be in the transmission connection control table. The source MAC address, destination MAC address, and type fields may indicate the source address, destination address, and type of the isochronous data frame 630 transmitted through a wireless connection, respectively. The source MAC address, destination MAC address, and type fields may correspond to fields in a header of an Ethernet packet and may be used when determining whether a received Ethernet packet is a pre-registered isochronous packet or converting the received Ethernet packet into the isochronous data frame 630. The buffer index may refer to a number of a packet buffer in which a packet is stored before wireless transmission. The band index, channel index, and slot index may indicate a frequency band, wireless channel, and a number of a slot used for wireless transmission of an isochronous data packet, respectively.

Table 5 may indicate an example configuration of an entry in the reception connection control table.

TABLE 5

| Parameters | Descriptions |
|---|---|
| Index | Connection Control Entry Index |
| Active | Active State of Connection Control Entry |
| | (0: Not Active, 1: Active) |
| Source MAC | Source MAC Address of Ethernet Packet |
| Address | |
| Destination | Destination MAC Address of Ethernet Packet |
| MAC Address | |
| Type | Type Field Value of Ethernet Header |
| Band Index | Frequency Band Index in which MAC frame is received |
| Channel Index | Wireless Channel Index in which MAC frame is received |
| Slot Index | TDM Slot Index in which MAC frame is received |
| TX Slot Index | TDM Slot Index for MAC frame transmission |
| | (0xFF means unallocated) |
| Buffer Index | TX Buffer Index allocated for MAC Frame Transmission |

The Index field may indicate an index of a connection control entry. The Active field may indicate an active state of current entry information. The active state of entry information may indicate the validity of the entry information. Like the transmission connection control table, the index field and the active field may not be in the reception connection control table depending on the implementation method (e.g., the array list or connection list) of the reception connection control table. The Source MAC Address, Destination MAC Address, and Type fields may indicate the source address, destination address, and type of the isochronous data frame 630 transmitted through a wireless connection, respectively. The source MAC address, destination MAC address, and type fields may correspond to fields in a header of an Ethernet packet and may be used to restore an Ethernet header when the received isochronous data frame 630 is converted into the Ethernet packet. The band index, channel index, and slot index may indicate a frequency band, wireless channel, and a number of a slot used for wireless transmission of an isochronous data packet, respectively. When devices designated as a destination and source of the isochronous packet are all registered in the same AP, the received isochronous data frame 630 may be wirelessly transmitted again in the form of a frame without being converted into the Ethernet packet. The TX slot index and the buffer index may indicate a number of a slot and a number of a buffer for wireless transmission when the isochronous data frame 630 is transmitted again in the form of a frame.

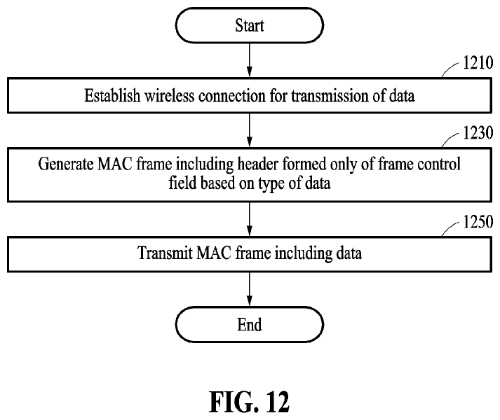

FIG. 12 is a flowchart illustrating a communication method for a TSN according to an embodiment.

Operations 1210 to 1250 may be performed by an electronic device 1300 of FIG. 13. The electronic device 1300 may perform the communication method described with reference to FIGS. 1 to 11. The electronic device 1300 may include a device (e.g., the AP 250, the ED 270, the IAC 210, the sensor 130 and the actuator 150 of FIG. 1, etc.) performing communication based on the TSN 200 of FIG. 2. For example, operations 1210 to 1250 may be substantially the same as the communication method in a downlink in which the AP 250 transmits data to the ED 270 and the communication method in an uplink in which the ED 270 transmits data to the AP 250.

The electronic device 1300 may include a receiver (e.g., a MAC frame receiver 1310 and, an Ethernet packet receiver 1320), a data frame processor (e.g., a non-isochronous frame processor 1330, an isochronous frame processor 1350), and a memory (e.g., a memory 1340). The MAC frame receiver 1310 may receive a MAC frame, determine the type of the MAC frame, and process the MAC frame. The Ethernet packet receiver 1320 may receive an Ethernet packet, determine the type of the packet, and process the packet. The non-isochronous frame processor 1330 may process a non-isochronous data frame (e.g., the non-isochronous data frame 610 of FIG. 6) or a non-isochronous packet. The isochronous frame processor 1350 may process an isochronous data frame (e.g., the isochronous data frame 630 of FIG. 6) or an isochronous packet. When receiving an isochronous data frame, the isochronous frame processor 1350 may restore an Ethernet packet based on a parameter stored in the reception control connection table (e.g., Table 5). When receiving an isochronous packet, the isochronous frame processor 1350 may generate a MAC frame (e.g., an isochronous data frame) by compressing protocol information. The memory 1340 may include the transmission control connection table (e.g., Table 4), the reception control connection table (e.g., Table 5), and the transmission buffer. The Ethernet packet receiver 1320 may receive an Ethernet packet from an external device. The Ethernet packet receiver 1320 may search the transmission control connection table (e.g., Table 4) stored in the memory 1340 and determine the data type of the received Ethernet packet. When a valid entry including parameters matching parameters (e.g., the source MAC address, destination MAC address, type, etc.) in a header of the received Ethernet packet is found, the Ethernet packet receiver 1320 may determine the received Ethernet packet as an isochronous data packet and when a valid entry is not found, determine the received Ethernet packet as a non-isochronous data packet. Whether a packet includes isochronous data may be determined based on various standards. For example, whether the received Ethernet packet is an isochronous data packet may be determined using parameters (e.g., the source MAC address, destination MAC address, type, etc.) in a header of a received Ethernet packet and in this case, a packet set to a certain type among packets transmitted from a predetermined source to a destination may be classified as an isochronous data packet. Even when the source and destination are the same, when the packet types are different from each other, the received Ethernet packet may be determined as a non-isochronous packet, and even when the packet types are the same each other, when the received Ethernet packet is not transmitted from a predetermined source to a destination, the received Ethernet packet may be determined as a non-isochronous packet. According to an embodiment, the Ethernet packet receiver 1320 may classify an isochronous data packet and a non-isochronous packet using information in headers of an UDP or IP protocol or Ethernet, UDP, and IP header information. When a received Ethernet packet is determined as an isochronous packet, the Ethernet packet receiver 1320 may transmit the received packet to the isochronous frame processor 1350. The isochronous frame processor 1350 may remove the Ethernet header from the received packet and then store the packet in a transmission buffer designated by the buffer index. The memory 1340 may include the transmission buffer. When the received Ethernet packet is determined as a non-isochronous packet, the Ethernet packet receiver 1320 may transmit the received Ethernet packet to the non-isochronous frame processor 1330.

In operation 1210, the electronic device 1300 may establish a wireless connection for transmission of data (e.g., the isochronous data frame 630). Operation 1210 may be substantially the same as a wireless connection establishment procedure described with reference to FIG. 8.

In operation 1230, the electronic device 1300 may generate a MAC frame (e.g., the isochronous data frame 630 of FIG. 6) including a header (e.g., a MAC header) formed only of a frame control field (e.g., the frame control field 530 of FIG. 5) based on the type of data (e.g., isochronous data). The electronic device 1300 may increase the efficiency of transmission by generating the isochronous data frame 630 with a minimized header.

In operation 1250, the electronic device 1300 may transmit a MAC frame (e.g., the isochronous data frame 630) including data (e.g., isochronous data) to other electronic devices. For example, wireless communication using the isochronous data frame 630 may be performed between an ED (e.g., the ED 270) and an AP (e.g., the AP 250). The electronic device 1300 may receive a MAC frame from other electronic devices. For example, the ED 270 may receive a MAC frame from the AP 250 and the AP 250 may receive a MAC frame from the ED 270. A downlink reception procedure in which the ED 270 receives data from the AP 250 may be substantially the same as an uplink reception procedure in which the AP 250 receives a MAC frame from the ED 270.

The MAC frame receiver 1310 of the electronic device 1300 may determine whether the received MAC frame is an isochronous data frame (e.g., the isochronous data frame 630) through a frame type field (e.g., the frame type field 537), which is the lower field of a frame control field (e.g., the frame control field 530 of FIG. 5) of the received MAC frame. When a MAC frame received by the MAC frame receiver 1310 is an isochronous data frame, the MAC frame receiver 1310 may determine whether a valid entry including parameters matching information (e.g., the band index, channel index, slot index, etc.) on a wireless resource (e.g., a slot) used for receiving a MAC frame is in the MAC frame by searching the reception connection control table (e.g., Table 5). When a valid entry is found, the MAC frame receiver 1310 may process the received isochronous data frame differently according to the value of the TX slot index field in the entry. For example, when the value of the TX slot index field is set to 0xFF, the MAC frame receiver 1310 may transmit the received isochronous data frame to the isochronous frame processor 1350. The isochronous frame processor 1350 may convert isochronous data into an Ethernet packet form by restoring a header of the Ethernet packet using the source MAC address, destination MAC address, and type fields stored in the reception connection control table. When the TX slot index field is set to the valid value other than 0xFF, the MAC frame receiver 1310 may store the received isochronous data frame in a buffer designated by the buffer index for transmitting to other EDs in the coverage of the AP 250. When the value of the frame type field 537 of the received MAC frame is set to isochronous data but a valid entry matching wireless resource information (e.g., the band index, channel index, slot index, etc.) used for receiving a MAC frame is not found, the MAC frame receiver 1310 may discard the MAC frame. When the value of the frame type field 537 of the received MAC frame is set to non-isochronous data, the MAC frame receiver 1310 may transmit the MAC frame to the non-isochronous frame processor 1330.

FIGS. 13 and 14 are schematic block diagrams illustrating an electronic device according to an embodiment.

Referring to FIG. 14, according to an embodiment, an electronic device 1400 may perform the communication method described with reference to FIGS. 1 to 13. The electronic device 1400 may include the electronic device 1300 described with reference to FIG. 13. The electronic device 1400 may include a memory 1410 and a processor 1430.

The memory 1410 (e.g., the memory 1340 of FIG. 13) may include one or more memories. The memory 1410 may store instructions (or programs) executable by the processor 1430. For example, the instructions may include instructions for executing operations of the processor 1430 and/or operations of each component of the processor 1430.

The memory 1410 may include one or more computer-readable storage media. The memory 1410 may include non-volatile storage elements (e.g., a magnetic hard disk, an optical disc, a floppy disc, flash memory, electrically programmable memory (EPROM), and electrically erasable and programmable memory (EEPROM).

The memory 1410 may be a non-transitory medium. The term “non-transitory” may indicate that a storage medium is not embodied in a carrier wave or a propagated signal. However, the term “non-transitory” should not be interpreted to mean that the memory 1410 is non-movable.

The processor 1430 (e.g., the non-isochronous frame processor 1330 and the isochronous frame processor 1350 of FIG. 13) may include one or more processors. The processor 1430 may process data stored in the memory 1410. The processor 1430 may execute computer-readable code (e.g., software) stored in the memory 1410 and instructions triggered by the processor 1430.

The processor 1430 may be a hardware-implemented data processing device having a circuit that is physically structured to execute desired operations. For example, the desired operations may include code or instructions in a program.

For example, the hardware-implemented data processing device may include a microprocessor, a central processing unit (CPU), a processor core, a multi-core processor, a multiprocessor, an application-specific integrated circuit (ASIC), and a field-programmable gate array (FPGA).

The operations performed by the processor 1430 may be substantially the same as the communication method described with reference to FIGS. 1 to 12 according to an embodiment. Accordingly, detailed descriptions thereof are not repeated herein.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the description of a processing device is singular; however, one of ordinary skill in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the examples may be recorded in non-transitory computer-readable media including program instructions to implement various operations of the examples. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter.

The above-described hardware devices may be configured to act as one or more software modules in order to perform the operations of the above-described examples, or vice versa.

As described above, although the examples have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A communication method comprising:
establishing a wireless connection for transmission of data;
generating a medium access control (MAC) frame comprising a header formed only of a frame control field based on a type of the data; and
transmitting the MAC frame comprising the data.

2. The communication method of claim 1, wherein the type of the data is isochronous data.

3. The communication method of claim 1, wherein the establishing of the wireless connection comprises transmitting a frame comprising identification information on transmission of the data and information on an upper protocol of the MAC frame.

4. The communication method of claim 3, wherein the identification information comprises at least one of a wireless connection identifier (CID), a band index, a channel index, and a slot index.

5. The communication method of claim 3, wherein the information on the upper protocol comprises information on compression and restoration of a header of the upper protocol.

6. An electronic device comprising:
one or more memories configured to store one or more instructions; and
one or more processors electrically connected to the one or more memories and configured to execute the one or more instructions,
wherein, when the one or more instructions are executed by the one or more processors, the instructions cause the electronic device to perform a plurality of operations,
wherein the plurality of operations comprises:
establishing a wireless connection for transmission of data;
generating a medium access control (MAC) frame comprising a header formed only of a frame control field based on a type of the data; and
transmitting the MAC frame comprising the data.

7. The electronic device of claim 6, wherein the type of the data is isochronous data.

8. The electronic device of claim 6, wherein the establishing of the wireless connection comprises transmitting a frame comprising identification information on transmission of the data and information on an upper protocol of the MAC frame.

9. The electronic device of claim 8, wherein the identification information comprises at least one of a wireless connection identifier (CID), a band index, a channel index, and a slot index.

10. The electronic device of claim 8, wherein the information on the upper protocol comprises information on compression and restoration of a header of the upper protocol.

11. A communication method comprising:
by transmitting a frame comprising identification information on transmission of data and information on an upper protocol of a medium access control (MAC) frame, establishing a wireless connection for transmission of the data;
generating a MAC frame comprising a header formed only of a frame control field based on a type of the data; and
transmitting the MAC frame comprising the data.

12. The communication method of claim 11, wherein the type of the data is isochronous data.

13. The communication method of claim 11, wherein the identification information comprises at least one of a wireless connection identifier (CID), a band index, a channel index, and a slot index.

14. The communication method of claim 11, wherein the information on the upper protocol comprises information on compression and restoration of a header of the upper protocol.
